(19) United States
(12) Patent Application Publication
(10) Pub. No.: US 2025/0262119 A1
(43) Pub. Date: Aug. 21, 2025

(54) ITCH RELIEF DEVICE

(71) Applicant: NATIONAL UNIVERSITY OF SINGAPORE, Singapore (SG)

(72) Inventor: Bei Ning KOH, Singapore (SG)

(73) Assignee: NATIONAL UNIVERSITY OF SINGAPORE, Singapore (SG)

(21) Appl. No.: 19/057,562

(22) Filed: Feb. 19, 2025

(30) Foreign Application Priority Data
Feb. 21, 2024 (SG) 10202400468W

(51) Int. Cl. A61H 15/00

(52) U.S. Cl. CPC A61H 15/0092; A61H 2015/0042; A61H 2201/0153; A61H 2201/1695

(57) ABSTRACT

The present invention relates to an itch relief device which comprises a spherical roller having an insert and an external layer overmoulded over the insert, the insert being heavier than the external layer, and a housing. The housing further comprises a cavity for retaining the spherical roller and shaped to prevent displacement of the spherical roller within the housing, and an aperture having a maximum dimension smaller than an outer diameter of the spherical roller, a portion of the spherical roller protruding through the aperture to contact skin of a user, wherein the external layer comprises a plurality of regularly spaced protrusions extending outwardly, away from the insert, and wherein, as the housing is moved over the skin, contact with the skin induces the spherical roller to roll, thereby bringing successive ones of the protrusions against the skin.

### CROSS-REFERENCE TO RELATED APPLICATIONS

This application claims the benefit and priority of Singaporean patent application number 10202400468W, filed Feb. 21, 2024. The entire disclosure of the above application is incorporated herein by reference.

### TECHNICAL FIELD

The present invention relates, in general terms, to an itch relief device. In particular, the present invention relates to an itch relief device comprising a spherical roller having a plurality of protrusions for use on skin to facilitate itch relief without causing skin damage.

### BACKGROUND

This section provides background information related to the present disclosure which is not necessarily prior art.

Itchy skin is an irritating sensation on the skin that triggers a scratching reaction to relieve the sensation. Itchy skin, referred to as pruritus, is caused by various factors including skin conditions, nerve disorders, allergic reactions, psychiatric conditions and internal diseases. Repeated scratching can cause raised thick areas of skin that might bleed or become infected.

Eczema, or atopic dermatitis, is a chronic skin disorder that causes itchy, rough and cracked patches of skin. In most cases, symptoms come and go and vary in severity. Flare-ups refer to periods when symptoms worsen, while remissions are when symptoms improve or clear up. The appearance of skin affected by eczema will also depend on how much a person scratches their rashes.

Adults may experience eczema rashes that are more scaly, and permanently itchy. Medications for treating eczema symptoms include topical and oral anti-inflammatory corticosteroids. However, such medications should generally only be used for short periods due to the risk of side effects.

Scratching using fingernails or typical scratcher tools to relieve itch involves the physical action of rubbing or scraping the skin surface with force. Excessive scratching can damage the delicate skin barrier, leading to open and weeping sores. Scratching also increases infection and inflammation risk that can lead to a more severe and prolonged eczema flare-up. Constant itching and the marred appearance of the skin can have a psychological impact, contributing to stress, anxiety and decreased quality of life for individuals with eczema.

It is desirable to overcome or alleviate at least one of the above-described problems by providing a tool or device that can facilitate the relief of the itchy sensation without causing damage to the delicate skin barrier, or at least to provide a useful alternative.

### SUMMARY

This section provides a general summary of the disclosure, and is not a comprehensive disclosure of its full scope or all of its features.

Disclosed herein is an itch relief device directed at alleviating the abovementioned problems with prior art itch relief, or to providing an alternative mechanism for itch relief. The device comprises a spherical roller with an insert and an external layer overmoulded over the insert. The insert is heavier, and generally more dense, than the external layer. The device also includes a housing comprising a cavity for retaining the spherical roller and shaped to prevent positional displacement of the spherical roller within the housing. The housing comprises an aperture having a maximum dimension smaller than an outer diameter of the spherical roller, with a portion of the spherical roller protruding through the aperture to contact skin of a user. The external layer comprises a plurality of regularly spaced protrusions extending outwardly, away from the insert, and when the housing is moved over the skin, contact with the skin induces the spherical roller to roll, thereby bringing successive ones of the protrusions against the skin.

As used herein, the term “prevent displacement of the spherical roller” refers to substantially preventing locational/positional (i.e., translational or linear) displacement—it is accepted that, during manufacturing, some degree of tolerance will be afforded to ensure the spherical roller has space to roll within the housing, but that tolerance will not be so much that the spherical roller rattles around within the housing. However, “prevent displacement” does not refer to rotational or angular displacement. Indeed, the spherical roller is intended to rotate within, and relative to, the housing.

The term “overmoulding” refers to applying a layer, by moulding, over and on a pre-formed part. Presently, the external layer is moulded over the pre-formed insert.

Advantageously, the exterior surface of the device is manufactured with stable and unreactive material.

Preferably, the cavity permits free rotation of the spherical roller about any rotational axis through a centre of the spherical roller (i.e., each rotational axis passes through the centre).

Advantageously, exterior surface of the device is manufactured from at least one of polyoxymethylene (POM), high-density polyethylene (HDPE), polypropylene (PP), polyethersulfone (PES), polyamide (PA), polycarbonate (PC-ABS) and acrylonitrile butadiene styrene (ABS).

Advantageously, the insert is manufactured from at least one of steel, stainless steel, aluminum, copper and nickel.

Preferably, the exterior surface of the spherical roller is made up of a material that can elastically deform with expansion and contraction of the insert. To that end, the tolerance between the internal surface of the housing and the outer diameter of the spherical roller is sufficient to enable rolling of the spherical roller even when the insert expands. It is anticipated that expansion will generally be small compared with the outer diameter of the spherical roller, so the tolerance remains insufficient to cause the spherical roller to noticeably locationally displace within, and relative to, the housing during use.

In a preferred embodiment, the insert is selected to have a predetermined weight thereby to apply a predetermined force to the skin when the aperture is directed downwardly, with the spherical roller against the skin.

Preferably, the total weight of the device is between 40g to 70 g.

Advantageously, the diameter of the device is between 30 mm to 40 mm.

In another embodiment, the protrusions comprise a polygonal cross-section and flat top, wherein edges of the flat top are well-defined. As used herein, the term “well-defined” refers to the edges being sharp (not so sharp as to cut, but sharp enough to apply force over a well-defined area, or along well defined lines, regardless of force applied by the device to the skin (albeit within the range of expected forces at which the device will be used), to interrupt itch pathways) rather than rounded. This ensures pressure is applied over well-defined lines and areas, to interrupt itch pathways. This is to be contrasted with rounded-edged surfaces that apply pressure over a greater area the further into the skin they are pushed—i.e., with greater force.

Advantageously, the spacing between the base of each protrusion is between 1.0 mm to 2.5 mm laterally.

Preferably, the spacing between the base of each protrusion is between 1.5 mm to 4.0 mm across rows and diagonally.

In an embodiment, wherein the spherical roller is made up of two hemispheres connected by an attachment mechanism.

Preferably, the attachment mechanism is used to attach or detach the two hemispheres to enable exchange of the insert with an alternative insert.

Advantageously, by overmoulding a lighter external layer over a heavier insert, the insert can provide downward pressure during use, while the external layer deforms in a predetermined way, to relieve itch while avoiding damaging the skin.

Advantageously, the cavity is shaped to retain the spherical roller and facilitate contact between the spherical roller and skin, while also preventing the roller from inadvertently coming out of the housing. This is achieved by a cavity that is shaped (including being sized) to receive most of the roller, while a portion of the roller projects through an aperture in the housing thereby to come into contact with the skin.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Embodiments of the present invention will now be described, by way of non-limiting example, with reference to the drawings in which:

FIG. 1 illustrates a front view of a spherical roller with cross-sectional view of the housing (which can interchangeably be referred to as a “holder”) according to an embodiment of the invention.

FIG. 2 illustrates a front view of a spherical roller with a transparent external layer to permit visualisation of the insert within the roller, according to an embodiment of the invention.

FIG. 3 illustrates a top hemisphere of the spherical roller showing a plurality of protrusions or bumps disposed on the roller according to an embodiment of the invention.

FIG. 4 illustrates a top half of a metal insert according to an embodiment of the invention.

FIG. 5 illustrates a top hemisphere of the spherical roller with a plurality of protrusions or bumps disposed on the roller, the external layer being transparent to permit visualisation of the insert within the roller, according to an embodiment of the invention.

FIG. 6 illustrates an itch relief device according to an embodiment of the invention.

Corresponding reference numerals indicate corresponding parts throughout the several views of the drawings.

### DETAILED DESCRIPTION

The present invention relates, in general terms, to an itch relief device. In particular, the present invention relates to a spherical roller having a plurality of protrusions for use on skin to facilitate itch relief without causing skin damage.

As used herein, the term “spherical roller” will be used to including a “substantially spherical roller”, or roller otherwise shaped to freely roll about any axis of rotation. The spherical roller has a plurality of protrusions extending outwardly, away from the insert—the protrusions may be part of the external layer, or may extend from the external layer. Despite the protrusions causing variation in the distance from the centre of the spherical roller to the outermost surface thereof, the roller will still be described as “spherical” as it can roll with the same effort about any axis of rotation passing through its centre, while occupying the same space.

Hereinafter, the system and method according to the present invention will be described in detail with reference to FIG. 1 through FIG. 6 according to the preferred embodiments. It is to be understood that limiting the description to the preferred embodiments of the invention is merely to facilitate discussion of the present invention. Various modifications may be made, to the preferred embodiments, without departing from the scope of the appended claims.

FIG. 1 illustrates and discloses a preferred embodiment of an itch relief device 100 of the present invention. According to FIG. 1, the itch relief device 100 comprises a substantially spherical roller or rollerball 102 having an insert, and an external layer 105 overmoulded over the insert. For illustrative purposes, the insert is formed from metal. The itch relief device 100 further comprises a housing 104 for the spherical roller or rollerball 102. The external layer has a plurality of protrusions or bumps 106 that are regularly spaced over the surface of the spherical roller 102. The spacing may be substantially uniform, such that a spacing between neighbouring or closest ones of the protrusions is kept, to the extent possible, uniform. Such uniform spacing ensures a consistent amount of relief of itching sensation. The protrusions extend away from the insert (i.e., outwardly of the roller 102) to contact the skin of the user, during use.

The spherical roller relieves itch when the device is used by moving the housing 104 over the skin (not shown) of the user, with the protrusions in contact with the skin. This action causes rolling of the spherical roller 102 on itchy skin surface, and can provide a massaging sensation. The plurality of protrusions or bumps 106 press into and interrupt the itch pathways, or nervous pathways, to provide a sensation similar to scratching. The rolling mechanism ensures no physical action of rubbing or scraping is applied to the skin surface, regardless of how vigorously the device is used.

The housing or the holder 104 of the spherical roller features a design that does not fully encase the spherical roller or rollerball 102. Instead, the housing 104 comprises a cavity, defined in internal surface 108, for retaining the spherical roller 102. The cavity is shaped to prevent displacement of the spherical roller 102 within the housing 104. It is so shaped by the internal surface 108 at least partially conforms to the external diameter d of the spherical roller 102. As used herein, ‘partial conformance’ refers to at least part of the internal surface 108 being in contact with the protrusions, such that the spherical roller 102 cannot displace within the housing 104, or cannot displace to any degree that degrades function of the device 100, yet with a small amount of tolerance (i.e., the diameter of the internal surface 108 being slightly larger than the diameter d) to permit free rotation of the spherical roller 102. That free rotation avoids scratching and dragging of the spherical roller 102 on the skin.

The housing 104 also comprises an aperture 110 having a maximum dimension w that is smaller than diameter d. The aperture 110 is still large enough that a portion of the spherical roller 102 protrudes through the aperture 110 to contact the skin—that portion of the roller 102 is within the box generally designated 112.

This device 100 offers targeted itch relief, enabling users to apply rolling motion precisely where needed and with ease. Additionally, the housing or holder 104 rotatably supports and allows for free rolling of the spherical body in any direction—i.e., about any axis of rotation passing through the centre of the roller 102. In particular, as the housing 104 (which is grasped by the user during use) is moved over the skin, contact between the skin and the portion of the roller 102 which, at any point in time, protrudes from the aperture 110 into the box 112, induces the spherical roller 102 to roll, thereby bringing successive ones of the protrusions 106 against the skin.

The housing 104 may be a single or unitary component that is permanently sealed around the roller 102—e.g., by ultrasonically welding parts of the housing together. In other embodiments, the housing 104 is formed from two or more parts that are releasably engaged to enable the housing 104 and roller 102 to be formed separately, with the roller 102 thereafter inserted into the housing 104. The parts of the housing may connect by screw threaded fitting, friction fit or any other appropriate means.

The housing may be shaped to have a similar, or the same, shape as that of the roller. For example, the housing may be truncated sphere of larger diameter than the roller, where the truncation is formed by the aperture. The housing may instead be shaped to be gripped by the hand of a user. To that end, the different sized housing may be provided, for a user to select that which best first in their hand.

The external layer 105 of the device is manufactured from a stable material (for the temperature range, humidity and other conditions of the environment in which the device is intended to be used), for example plastics such as polyoxymethylene (POM), high-density polyethylene (HDPE), polypropylene (PP), polyethersulfone (PES), polyamide (PA), polycarbonate (PC-ABS), acrylonitrile butadiene styrene (ABS), Silicone or combinations thereof. The material from which the external layer 105 is formed is, in some embodiments, unreactive—e.g., not react with bodily fluids or topical creams such as moisturizers or topical steroids even after prolonged contact.

The material used to make the external layer 105 may be able to elastically deform, thereby to follow expansion and contraction of the insert. Where the insert is made from, for example, metal or another material having relatively high thermal mass when compared with the external layer, the insert may shrink when chilled (e.g., in the freezer or refrigerator), and the external layer 105 will contract along with it-due, e.g., to elasticity of the material from which the external layer is formed. This enables the device 100 to be used while cold, which enhances relief of itching sensations. Further, certain engineered plastics that have improved thermal conductivity may also be used for the external layer 105, to enhance conduction of heat from the skin into the insert, which would cause the insert to expand. Due to the high thermal mass of the insert, the insert may also be able to be warmed, where warmth would bring relief to the user.

Similarly, the cavity should be large enough to retain the spherical roller 102 at a standard use temperature—e.g., room temperature or 25° C. If the cavity is sufficiently large for user at room temperature, then it will also be sufficient large for use when the roller is chilled—the roller can shrink when chilled, but not expand.

Plastics as described above are known to be highly mouldable and this allows the protrusions or bumps 106 of the spherical roller or rollerball 102 to be moulded into rigid polygonal shapes with flat top and well-defined edges. A flat top 304 has been shaded for illustration purposes. The shape of the protrusions or bumps 106 is an important feature for maintaining the shape of the well-defined edges—the edges should be provide a concentrated force similar to a scratching sensation by pressing into and interrupting the itch pathways. To that extent, the protrusions 106 should be sufficiently stiff so as not to significantly deform during use—i.e., deform to an extent that erodes the efficient delivery of itch relief—but, in some embodiments, not so stiff that they scratch the skin.

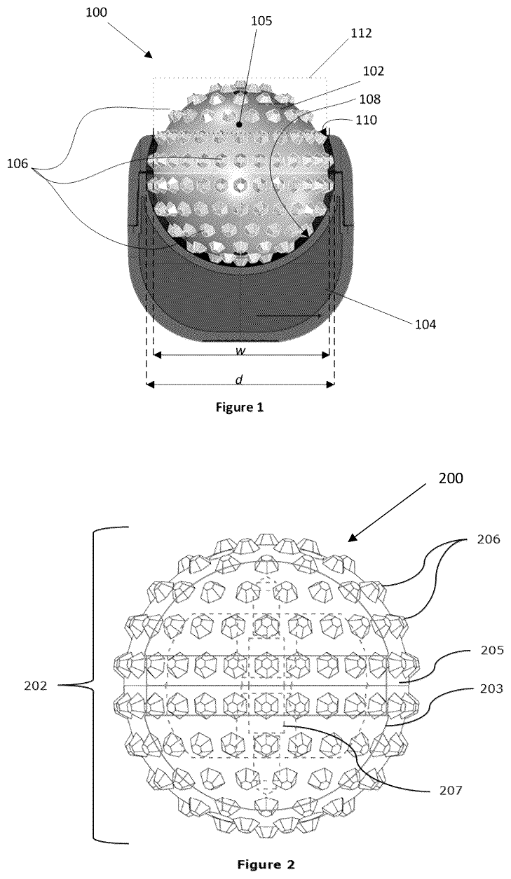

FIG. 2 illustrates a spherical roller 202 of the itch relief device 200 with visual representation of an insert 203 within the roller according to an embodiment of the invention. The insert 203, which will presently be described as being formed from metal for the purpose of illustration, though some non-metals may be used as alternatives, is heavier than the external layer 105. The metal insert 203 thus ensures the rollerball is of sufficient weight—e.g., between 40 g to 70 g, with the diameter of the device 100 being between 30 mm to 40 mm—for efficient and effective application of pressure during rolling. Less downward pressure is thus required by a user to increase or maintain effectiveness during use. The weight also reduces shaking within the holder, allowing smooth rolling.

The thickness and design of the internal metal insert 203 may be adjusted to provide ideal weight of the spherical rollerball and thus ideal pressure on skin surface. A thicker metal insert may be used for more downward pressure, and A thinner metal insert may be used for less pressure on more sensitive skin surface. The thickness is the wall thickness of the insert which may thus be hollow, having an internal cavity (not shown)—the weight of the insert being defined by determining the volume of the internal cavity. Thus, inserts of the same outer dimensions can have different weight, by varying the volume of the internal cavity. The ‘thickness’ of the metal insert thus refers to the wall thickness around the internal cavity. According to a preferred embodiment, the insert 203 is selected to have a predetermined weight thereby to apply a predetermined force or downward pressure to the skin when the aperture 110 is directly downwardly onto the skin.

The insert disposed within the spherical body is manufactured from at least one of steel, stainless steel, aluminium, copper, nickel or alloys thereof. For additional weight, the insert itself may comprise multiple materials, with one formed around the other. For example, the insert may comprise a lead core surrounded by a spherical steel shell.

The itch relief device 200 may be cooled in the refrigerator or any other household appliance with storing capability at low temperatures, to provide a cooling effect through the external layer 105 to the user's skin, during use. The thickness of the external layer 205 overmoulded over the metal insert 203 may be reduced to allow better thermal conductivity i.e., the ability of the external layer 205 to pass the cooling sensation to skin, from the internal metal insert 203 after the device 200 has been cooled in the refrigerator. Certain engineered plastics that have improved thermal conductivity such as polymer composites may also be used to make the external layer.

As shown in FIG. 2, and more clearly seen in FIG. 4, disposed within the metal insert 203 is an attachment means or mechanism 207. The spherical roller 202, and thus the external layer 205 and insert 203, may be formed in multiple parts-presently there are two parts. Each of the two parts is a hemisphere. The attachment means or mechanism 207 is configured to fix the two hemispheres together, to form the assembled roller 202. In some embodiments, once assembled, the roller 202 cannot be disassembled. In other embodiments, the roller 202 can be detached (and reassembled), by releasing the attachment means or mechanism 207, to permit cleaning, exchanging of the insert for a heavier or lighter insert, and so on. The attachment means or mechanism may comprise a friction fit to hold the hemispheres together, or cooperating screw threaded members, one in each hemisphere such that relative rotation between the hemispheres can attach and detach them, or other means of connection. Notably, friction fit may be appropriate even for heavier inserts, since containment of the insert in the housing (with effectively no space for relative movement between the parts of the assembled roller) will prevent the two halves from coming apart during use.

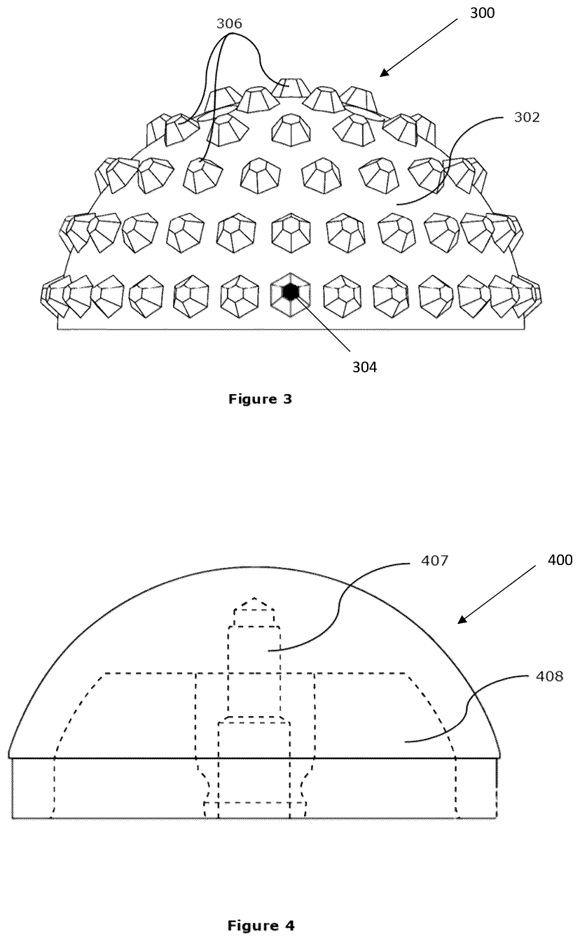

FIG. 3 illustrates a top hemisphere 300 of the spherical roller 302 showing a plurality of protrusions or bumps 306 disposed on the spherical roller according to an embodiment of the invention. The spherical roller 302 is made up of two hemispheres (i.e., top hemisphere 300 and bottom hemisphere (not shown)) connected by the attachment mechanism 207 described with reference to FIG. 2. The protrusions or bumps 306 of the spherical roller or rollerball 302 have a polygonal shape, with flat top (in a form of frustum) and well-defined edges. Preferably, the shape of the polygon is hexagon, though triangular, square, pentagonal, octagonal and other cross-sectional shapes may be used. In some embodiments, a mixture of different shapes of protrusion are provided—e.g., protrusions with larger flat tops (e.g., octagonal protrusions) to interrupt itch pathways in the nervous system, and protrusions with smaller flat tops (e.g., triangular protrusions) to provide direct itch relief. The protrusions may be irregularly spaced but, in general, will be regularly spaced. The protrusions may be placed in rows. The distance between the base of neighbouring, regularly spaced protrusions (i.e., protrusions closest to one another) defines the spacing therebetween and may be between 0.5 mm and 4.0 mm laterally (i.e., within a row), and preferably between 1.0 mm and 3.0 mm, and more preferably between 1.0 mm to 2.5 mm. The protrusions of one row may be offset from the protrusions of neighbouring rows (i.e., nearest rows). The protrusions of one row may be spaced from the protrusions of neighbouring rows by between 0.5 mm and 5.0 mm, preferably between 1.0 mm and 4.5 mm, and more preferably between 1.5 mm to 4.0 mm. To the extent possible, the spacing between protrusions may be a consistent distance, to ensure consistent itch relief and smooth rolling of the rollerball 302 inside the housing or holder 104.

FIG. 4 illustrates a top half of a metal insert 400 according to an embodiment of the invention. The dashed lines visually represent hidden elements. There is an attachment mechanism 407 disposed along the central axis of the spherical roller. The attachment mechanism 407 is used to attach or detach the two hemispheres (top 300 and bottom hemispheres of the spherical roller or rollerball). In a preferred embodiment, the attachment mechanism 407 may be used to attach or detach the two hemispheres, in order to change the internal weight insert 400, to change the downward pressure applied by the device during use. There is a cavity 408 inside of the metal insert by choice of design. That cavity may be filled with material to increase the weight of the insert, or may be enlarged to decrease that weight.

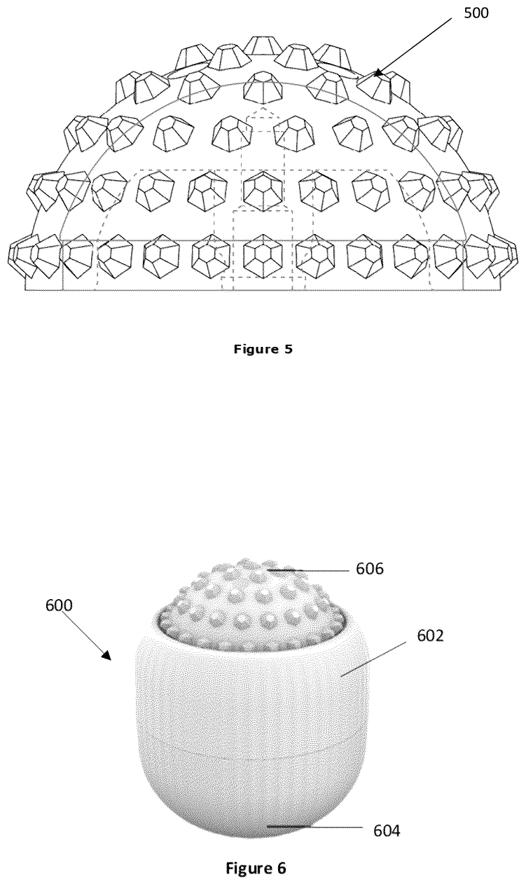

The configuration of the top hemisphere 300 with the internal metal insert 400 disposed within the top hemisphere is illustrated in FIG. 5.

FIG. 6 illustrates a perspective view of the itch relief device according to a preferred embodiment of the invention. The housing 600 comprises two portions 602, 604, that are connected either permanently or in a manner to permit disassembly and reassembly. The connection may provide a friction fit or screw threaded connection, or other means of connection. This enables the spherical roller to 606 to be inserted into the housing 600, and the housing 600 closed or assembled around the spherical roller 606 to hold the spherical roller 606 in position for use.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An itch relief device, comprising:
a spherical roller having an insert and an external layer overmoulded over the insert, the insert being heavier than the external layer; and
a housing comprising:
a cavity for retaining the spherical roller and shaped to prevent positional displacement of the spherical roller within the housing; and
an aperture having a maximum dimension smaller than an outer diameter of the spherical roller, a portion of the spherical roller protruding through the aperture to contact skin of a user,
wherein the external layer comprises a plurality of regularly spaced protrusions extending outwardly, away from the insert; and
wherein, as the housing is moved over the skin, contact with the skin induces the spherical roller to roll, thereby bringing successive ones of the protrusions against the skin.

2. The device of claim 1, wherein the exterior surface of the device is manufactured with stable and unreactive material.

3. The device of claim 1, wherein the cavity permits free rotation of the spherical roller about any rotational axis through a centre of the spherical roller.

4. The device of claim 2, wherein exterior surface of the device is manufactured from at least one of polyoxymethylene (POM), high-density polyethylene (HDPE), polypropylene (PP), polyethersulfone (PES), polyamide (PA), polycarbonate (PC-ABS), Silicone and acrylonitrile butadiene styrene (ABS).

5. The device of claim 1, wherein the insert is manufactured from at least one of steel, stainless steel, aluminium, copper and nickel.

6. The device of claim 1, wherein the exterior surface of the spherical roller is made up of a material that can elastically deform with expansion and contraction of the insert.

7. The device of claim 1, wherein the insert is selected to have a predetermined weight thereby to apply a predetermined force to the skin when the aperture is directed downwardly, with the spherical roller against the skin.

8. The device of claim 1, wherein the total weight of the device is between 40 g to 70 g.

9. The device of claim 1, wherein the diameter of the device is between 30 mm to 40 mm.

10. The device of claim 1, wherein the protrusions comprise a polygonal cross-section and flat top, wherein edges of the flat top are well-defined.

11. The device of claim 1, wherein the spacing between the base of each protrusion is between 1.0 mm to 2.5 mm laterally.

12. The device of claim 1, wherein the spacing between the base of each protrusion is between 1.5 mm to 4.0 mm across rows and diagonally.

13. The device of claim 1, wherein the spherical roller is made up of two hemispheres connected by an attachment mechanism.

14. The device of claim 12, wherein the attachment mechanism is used to attach or detach the two hemispheres to enable exchange of the insert with an alternative insert.
